(19) United States
(12) Patent Application Publication
(10) Pub. No.: US 2023/0149887 A1
(43) Pub. Date: May 18, 2023

(54) REACTOR FILTER WASHER DRIER (R-FWD) APPARATUS AND METHODS OF USE THEREOF

(71) Applicant: ODH IP CORP., New York, NY (US)

(72) Inventor: Luke Rogers, Rockville, MD (US)

(73) Assignee: ODH IP CORP., New York, NY (US)

(21) Appl. No.: 17/931,220

(22) Filed: Sep. 12, 2022

Related U.S. Application Data
(60) Provisional application No. 63/278,862, filed on Nov. 12, 2021.

(51) Int. Cl. B01J 19/18; B01D 29/05; B01D 39/20; B01F 27/90; B01F 35/221; B01J 19/00

(52) U.S. Cl. CPC B01J 19/18; B01D 29/05; B01D 39/2027; B01F 27/90; B01F 35/2215; B01J 19/0013; B01F 2101/2204

(57) ABSTRACT

A reactor filter washer dryer (R-FWD) apparatus and methods of using the apparatus for producing washed and dried product of a reaction is disclosed. The R-FWD comprises a vessel defining a process chamber, a filter plate laterally disposed on the vessel base, an agitator assembly, a solids discharge port in the vessel operable to remove the solid fraction of the slurry retained by the filter plate, and a filtrate outlet in the vessel for outflowing the liquid phase of the slurry filtered through the filter plate.

### GOVERNMENTAL RIGHTS

This invention was made with government support under DARPA Cooperative Award # HR-001 1-16-2-0029 awarded by the Defense Advanced Research Projects Agency of the department of defense. The government has certain rights in the invention.

### CROSS REFERENCE TO RELATED APPLICATIONS

This application claims priority to U.S. Provisional Application No. 63/278,862, filed Nov. 12, 2021, the entire contents of which are hereby incorporated by reference.

### FIELD OF THE INVENTION

The present disclosure provides a reactor filter washer dryer (R-FWD) apparatus and methods of using the apparatus for producing washed and dried product of a reaction.

### BACKGROUND OF THE INVENTION

Historically, chemical reactions that form a slurry are conducted in a reactor, and the slurry is then transferred to another vessel to undergo filtration, washing, and drying (e.g., centrifuge, rotary drum filter, etc.). The transfer of slurries is always problematic. The process is time-consuming, and clogging of the tubing can occur depending on the slurry density. Further, if it is desired to run systems in parallel, a valve can be required to redirect the slurry. These valves are limited in their material of construction and can lead to process contamination through extractable and leachable pathways. Slurry transfers are typically completed by applying a head-space pressure that creates a pressure differential that facilitates the transfer of the material from one vessel to another. This again requires access to equipment such as compressed gas tanks, pressure gauges, pressure relief valves, etc.

What is needed is an apparatus that eliminates the transfer of material to a subsequent vessel, thereby eliminating the need for additional vessels, pumps, and other such processing equipment, significantly simplifying and streamlining a process.

### SUMMARY OF THE INVENTION

One aspect of the present invention encompasses a reactor filter washer dryer (R-FWD) apparatus. The apparatus comprises a vessel defining a process chamber. The vessel comprises vessel walls, a vessel top, and a vessel base. The vessel base and vessel top can be releasably sealed to the vessel walls. The vessel walls comprise a first and a second sealing rim at each end of the vessel walls, the vessel base is releasably sealed by a gasket interposed between the vessel base and the first sealing rim of the vessel walls, and the vessel top is releasably sealed by a gasket interposed between the vessel base and the second sealing rim of the vessel walls. In some aspects, the gasket is an EPDM gasket, an FEP-encapsulated silicone gasket, or a Kalrez-encapsulated gasket. In some aspects, the vessel is made of a Hastelloy™ C-276 6 inch schedule 10 pipe welded to a sintered C-22 Hastelloy™ filter plate with Inconel™ 625.

The R-FWD apparatus of the present invention also comprises a solids discharge port in the vessel operable to remove the solid fraction of the slurry retained by the filter plate; and a filtrate outlet in the vessel for outflowing the liquid phase of the slurry filtered through the filter plate. The solids discharge port can be in the vessel base.

The R-FWD apparatus of the present invention further comprises a filter plate laterally disposed on the vessel base wherein the filter plate is operable to retain a solid fraction of a slurry comprising a solid fraction and a liquid fraction. The filter plate can be a perforated support plate with filter mesh (metallic or non-metallic), welded multi-layer mesh, sintered wire mesh, or any combination thereof. In one aspect, the filter plate is a sintered C-22 Hastelloy™ filter plate with Inconel™ 625.

Additionally, the R-FWD apparatus of the instant invention comprises an agitator assembly. The agitator assembly comprises an impeller and agitator shaft, wherein the impeller is laterally disposed within the vessel above the filter plate, wherein the agitator shaft is attached at its distal end to the impeller in the vessel and extends through a mixing port in the vessel in rotatable and axially slideable relation; and a drive mechanism attached to the agitator shaft and operable to rotate the agitator shaft about its longitudinal axis. The impeller can have no predetermined direction of rotation and can be vertically movable to raise and lower the impeller. The agitator arm can be operable to stir a reaction medium, keep the slurry in suspension during filtration, smoothen a filter cake’s surface prior to applying spray wash, resuspend the cake during re-slurring, agitate the solids and removing cracks in the filter cake during drying, and any combination thereof.

The R-FWD apparatus of the present invention can further comprise temperature control device operable to control the temperature of the reaction medium. The temperature control device can be selected from a conduction device, a thermoelectric device, a resistance device, an impedance device, an induction device, a microwave dielectric heating device, and any combination thereof. Additionally, the apparatus can comprise a controller in functional communication with valves, sensors, and the agitator assembly.

### BRIEF DESCRIPTION OF THE FIGURES

FIG. 1 is a diagram of an aspect of an operational sequence of an R-FWD in a process.

FIG. 2 depicts a cross section of an aspect of an R-FWD apparatus.

FIG. 3 is a top perspective view of an aspect of an R-FWD apparatus.

FIG. 4 is a side cross section view of an aspect of the R-FWD apparatus with an overhead mixer in the raised position.

FIG. 5 is side view of an aspect of the R-FWD apparatus showing a solids discharge port closure operable to open and close the discharge port.

FIG. 6 is a top view of a filter plate in a process chamber of an R-FWD apparatus. A discharge port in the closed position is shown.

FIG. 7 is a bottom view of an R-FWD apparatus comprising a solids discharge port closure in the open position.

FIG. 8 is a bottom view of an R-FWD apparatus comprising a solids discharge port closure in the closed position.

FIG. 9 is a side view of an agitator assembly of the CFWD device of the instant invention. The agitator shaft is shown extending through the mixing port in the vessel top of the CFWD device.

FIG. 10 is a side perspective view of an impeller configuration.

FIG. 11 are various types and configurations of impellers.

FIG. 12 are diagrams depicting flow patterns generated in vessels by impellers and vessel designs.

FIG. 13 depicts the process used to produce an intermediate in the manufacture of Midazolam through the utilization of an R-FWD.

FIG. 14 schematically depicts a chemical process of synthesizing cisatracurium besylate.

FIG. 15A depicts synthesis of racemic R,S,-tetrahydropapverine (TP) precursor in the synthesis of cisatracurium besylate using a system comprising a STR of the instant invention.

FIG. 15B depicts separation of racemic R,S,-tetrahydropapverine (TP) with R,S naproxen to the R and S stereoisomers to produce the R-tetrahydropapaverine naproxen salt.

FIG. 16 depicts production of an intermediate in the manufacture of Midazolam using a R-FWD of the instant invention.

### DETAILED DESCRIPTION

The devices, systems, methods, and computer program products for data collection will be understood from the accompanying drawings, taken in conjunction with the accompanying description. It is noted that, for purposes of illustrative clarity, certain elements in various drawings may not be drawn to scale. Several variations of the system are presented herein. It should be understood that various components, parts, and features of the different variations may be combined together and/or interchanged with one another, all of which are within the scope of the present application, even though not all variations and particular variations are shown in the drawings. It should also be understood that the mixing and matching of features, elements, and/or functions between various variations is expressly contemplated herein so that one of ordinary skill in the art would appreciate from this disclosure that the features, elements, and/or functions of one variation may be incorporated into another variation as appropriate, unless described otherwise.

### I. Apparatus

One aspect of the present disclosure encompasses a reactor, filter, washer, dryer (R-FWD) apparatus. The apparatus functions as a reactor to carry out any chemical or biological reaction or fermentation where constant agitation is required, and where a product of the reaction is a slurry comprising a solid phase and a liquid phase, with the desired material having the option of being in either phase. The reaction process, filtering, washing, and drying are referred to hereinafter as a reaction process, all of which are performed in the reaction chamber. The apparatus can then be used to separate the solid phase from the liquid phase of the process, followed by washing and drying the solid phase. By consolidating the functions of a reactor with the filtering, washing, and drying steps to a single vessel, the R-FWD eliminates the need for an additional reactor, the transfer of a reaction product from a reactor to a subsequent vessel for completing the filtering, washing, and drying process of the solid phase of the slurry. This reduces non-value-added time, as transferring of slurry takes significant processing time, mitigates the need for a significant quantity of extra process equipment such as pumps or pressurized gases to push a slurry to a filtration vessel, , reduces the potential for clogging of lines and valves, and reduces the potential of contamination from impurities extracted/leached from these materials. Combining the functions of a reactor, filter, washer, and dryer apparatus would be ideal for miniature chemical or pharmaceutical manufacturing units or a pharmaceutical on demand (POD) unit where space and automation of a process are valued.

The R-FWD apparatus of the instant disclosure comprises a vessel defining a process chamber, a filter plate laterally disposed on the vessel base, an agitator assembly, a solids discharge port in the vessel operable to remove the solid fraction of the slurry retained by the filter plate, and a filtrate outlet in the vessel for outflowing the liquid phase of the slurry filtered through the filter plate. It will be recognized that the R-FWD apparatus can further comprise additional components or parts known to individuals of skill in the art suitable for the intended function of the reactor. Non-limiting examples of additional components or parts can be as described herein further below in Section I(e).

In an operational sequence of a process using the R-FWD apparatus, one or more reagents are introduced into the R-FWD process chamber and subjected to conditions appropriate for completing a reaction to form a slurry. The slurry is then filtered through the filter plate, resulting in a filter cake on the filter plate comprising the solid phase of the slurry. Keeping the slurry in suspension using the agitator assembly of the R-FWD during filtration assists in forming a homogeneous cake. The liquid phase of the slurry can be discarded, recycled for reuse in a similar or different process, or can continue on to other equipment for further processing if the liquid phase comprises a desired material of the chemical process.

To wash the filtered solids, a wash liquid is introduced into the vessel chamber and pressure and/or vacuum continue to be applied. This displaces the liquid fraction of the slurry with the wash liquid. This is sometimes referred to as cake washing or displacement washing. One of the advantages of the R-FWD is the ability to use the agitator assembly to smoothen the cake’s surface prior to applying spray wash for even washing of the entire bed (See Section I(c) below). As an additional washing option, a re-slurry washing (also known as cake repulping) can be performed if additional extraction or dissolving of impurities is necessary. The re-slurry process can also be used when a long contact time is needed between the wash fluid and the solids, or the displacement wash does not provide the required wash quality. The re-slurry process can comprise resuspending the cake in wash fluid with the impeller of the agitator assembly for thorough mixing with the wash solution. Each of the washing steps can be repeated once, twice, three times, or as many times as is necessary to obtain the desired purity of the solids.

The solids are then dried using vacuum, pressure drying, convection drying, or any combination thereof. The choice of a drying method depends on the behavior of the solids during drying. Vacuum and pressure drying, the most common drying methods used, involve the application of a vacuum or pressure source and agitation to draw or push the liquid phase through the filter plate. The agitation can be provided using the agitator assembly of the apparatus. During convection drying, hot, pressurized gas is blown through the solids and out of the filtrate outlet, eventually drying the solids. Unlike vacuum or pressure drying, convection drying does not require agitation. Non-limiting examples of gas include air or inerting gases such as nitrogen, carbon dioxide, argon, helium, or any combination thereof.

During the drying step, the agitator can be used to close cracks and compress the cake to reduce residual moisture level. This function helps to achieve uniform flow of liquid or gas through the filter cake, while helping to eliminate liquid and gas channeling that reduces the efficiency of displacement washing and gas blow through. Further reduction in cake moisture can be obtained by slowly rotating and lowering the paddle arms to scrape and de-lump the cake.

The degree to which solids are dried can and will vary depending on the particular process being performed by the R-FWD. For instance, the solids can be dried to yield a solid comprising less than 0.01%, 0.05%, 0.1%, 0.5%, 1%, 5%, 10%, 20%, 30%, 40%, 50%, 60%, 70%, 80%, 90%, or 99% final product moisture, or any % moisture within these ranges. The temperature and period of time used to dry a solid can and will vary depending on the solid and the level of humidity of the solid among other variable, and can be determined experimentally.

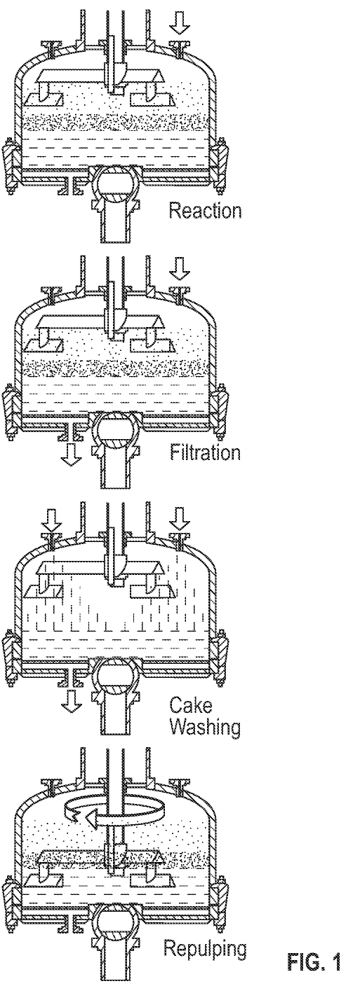

The final step in a process is the discharge of the dried solids. This step can be accomplished through the solids discharge port of the R-FWD apparatus. To discharge the solids, the solids discharge port is opened, and the solids removed. The agitator can be used to facilitate discharge of the solids. For instance, when the solids discharge port is on a side of the vessel, the agitator is slowly lowered as it rotates, effectively moving product to the solids discharge port on the side of the vessel or in the vessel base. There are certain applications where the desired product to be discharged is not a dry solid. The paddles can be designed to facilitate flexible discharge, which allows for wet solids, slurries, or even liquid to be discharged. Solids can also be collected by removing the vessel base to access the filter cake. In some aspects, the process can further comprise the step of backwashing the filter plate with a wash liquid to dislodge and remove any residue of solids that adhered to the medium after cake discharge. FIG. 1 shows an aspect of an operational sequence of an R-FWD in a process and comprises the following steps: (1) reaction, (2) filtration, (3) cake washing, optionally (4) repulping, (5) pressure drying, (6) vacuum drying, and (7) cake discharge. It will be understood by those of skill in the art that the sequence is dependent on the target molecule being synthesized and these sequence steps can vary in their order.

The R-FWD is well suited for handling flammable, toxic, corrosive and odor-noxious materials, as the apparatus provides product isolation, minimal operator exposure, reduced product handling, provides for very high solvent recovery, and environmental protection against solvent vaporization. Additionally, the level of containment supplied can comply with GMP and other health and safety requirements that companies often face. The R-FWD apparatus can be designed to operate under vacuum and/or pressure. For all these reasons, the R-FWD apparatus can be used in pharmaceutical, fine chemical, dye and paint production, and wastewater treatment applications. As described further below, the reactor of the present invention can be included within a reactor module or kit, such as in a POD. The reactor modules can comprise the R-FWD of the present invention, mixing chambers, tube style or plug-flow reactors, or any combination thereof.

The R-FWD apparatus can function as a reactor to carry out any chemical or biological reaction or fermentation in a reaction medium where constant agitation is required. The reaction medium is optionally subjected to reaction conditions to cause an intended reaction between the reagents, and products are continuously removed. The R-FWD can function as a batch reactor or a semibatch reactor. The R-FWD can also function as a continuous stirred tank reactor (CSTR), also known as a vat- or backmix reactor, or a mixed flow reactor (MFR). Batch reactors are reactors in which the reactants are added to the reactor at the start of the reaction. The reactants are allowed to react in the reactor for a fixed time. In some aspects, reagent feed can be added, product can be withdrawn, or a combination thereof during this time. The reaction products are removed at the end of the batch. Semibatch (semiflow) reactors operate much like batch reactors in that they take place in a single stirred tank with similar equipment. However, they are modified to allow reactant addition and/or product removal in time. In a CSTR, one or more reagents are continuously introduced into the reactor in a reactor input stream and stirred to ensure proper mixing of the reagents in the reaction medium. CSTRs are run at steady state, and a uniform composition is assumed throughout each reactor.

The reactions that may be conducted in a R-FWD using the reactor function of the device may include hydrogenations, polymerizations, synthesis of chemical compounds such as pharmaceuticals, catalytic reactions, petrochemical, crystallization, enzymatic reactions, and nanoparticle synthesis among others. R-FWDs can also be used as bioreactors or fermenters to conduct cell culture. Typical non-limiting applications include brewing, pharmaceuticals, wastewater treatment, biologicals, biopharmaceuticals, tissue engineering, microorganisms, plant metabolites, food production, hydrocarbon processing such as in the petrochemical industry, manufacturing in the semiconductor industry, and manufacture of quantum dots among others.

It will be understood that all the components of the R-FWD can be constructed from materials that meet the requirements of a desired process. The components can be constructed of the same or different materials based on the intended use of the reactor, and are known to individuals of skill in the art. Non-limiting examples of materials include metals, including but not limited to steel, metal alloys such as Hastelloy™ and Inconel™, stainless steel, aluminum, as well as plastics such as polyetheretherketone (PEEK), ceramics, glasss, polytetrafluoroethylene (PTFE), and fluoropolymers such as PVF (polyvinylfluoride), PVDF (polyvinylidene fluoride), PTFE (polytetrafluoroethylene), PCTFE (polychlorotrifluoroethylene), PFA or MFA (perfluoroalkoxy polymer; Teflon™), FEP (fluorinated ethylene-propylene), ETFE (polyethylenetetrafluoroethylene), ECTFE (polyethylenechlorotrifluoroethylene), FFPM/FFKM (Perfluorinated Elastomer [Perfluoroelastomer]), FPM/FKM (Fluoroelastomer [Vinylidene Fluoride based copolymers]), FEPM (Fluoroelastomer [Tetrafluoroethylene-Propylene]), PEPE (Perfluoropolyether), Perfluoropolyoxetane, composites, or any combination thereof. In some aspects, it could be beneficial to construct the components from, or comprise portions made of thermally conductive material or material that can withstand pressures that may accumulate in the process chamber.

### (A) Vessel

The R-FWD apparatus comprises a vessel. The vessel comprises vessel walls, a vessel top, and a vessel base, defining a process chamber. In some aspects, the R-FWD vessel can be made of a Hastelloy™ C-276 6 inch schedule 10 pipe welded to a sintered C-22 Hastelloy™ filter plate with Inconel™ 625. In some aspects, the vessel base is made of PEEK.

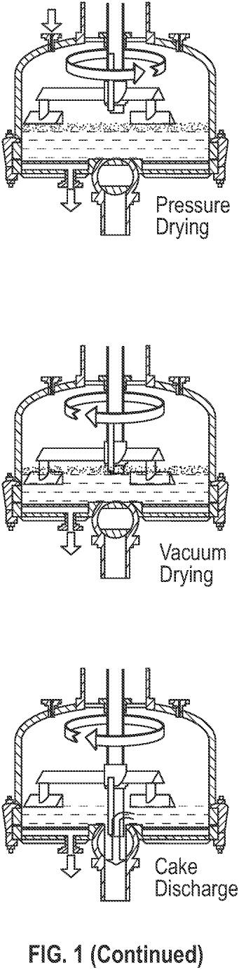

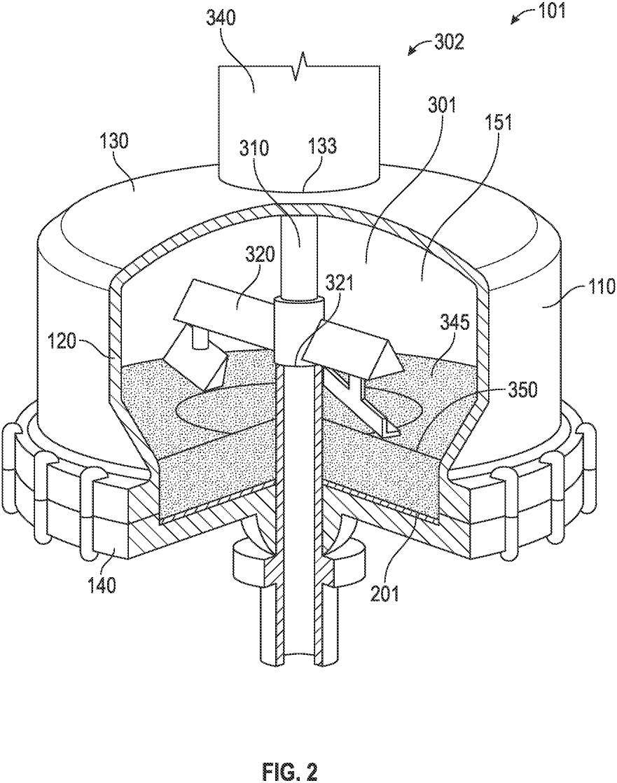

The vessel top, the vessel bottom, or both can be removably sealed to the walls of the vessel. Alternatively, the vessel top, the vessel bottom, or both can be in one part with the vessel walls. In some aspects, the vessel top and the vessel walls are in one part, and the vessel base is removably sealed to the walls of the vessel (FIG. 2). In other aspects, the vessel base and the vessel walls are in one part, and the vessel top is removably sealed to the walls of the vessel. In yet other aspects, the vessel base, the vessel walls and the vessel top are in one part. In some aspects, the vessel top and the vessel base are removably sealed to the walls of the vessel (See, e.g., FIGS. 3-8).

When the vessel base, the vessel top, or both are releasably sealed to the vessel walls, the vessel top and/or base can be releasably sealed to the vessel walls by a mechanical closure. Suitable mechanical closures are known in the art and generally comprise a means of engaging the vessel walls and the vessel base or vessel top to bring the vessel base or vessel top into sealing contact with the rim of the vessel walls (the sealing rim) to form a seal at the point of contact between the vessel base or top and the rim of the vessel. Mechanical closures include those normally used in applications where purity, contamination, and cleanability are of paramount importance such as in the pharmaceutical industry, food industry, and the like. Non-limiting examples of mechanical closures include a sanitary clamp or other suitable union such as clamps or unions of conventional design, including band clamps, sanitary clamps such as Ladish, Tri-Clover clamps, Tri-Clamps, S-Clamps, 3A pipe fittings, mated threads on the vessel top or base and the vessel walls, nuts and bolts, clips, or any combination thereof. Seals, gaskets, and O-rings can also be designed and used to ensure a tight seal between the cover and sealing rim. The material of the seals, gaskets, O-rings, or any combination thereof is generally inert to the reaction medium. For instance, the material can be elastomers, neoprene, EPDM rubber (ethylene propylene diene monomer rubber), coated elastomers such as fluoropolymer-coated elastomeric gaskets, such as PTFE-coated Viton™, and silicone encapsulated with fluorinated ethylene propylene (FEP) or a perfluoroelastomer such as Kalrez™. Other means of ensuring a fluid-tight seal between the cover and sealing rim can be envisioned.

The R-FWD comprises a fluid outlet in the vessel for outflowing the liquid phase (filtrate) of the slurry filtered through the filter plate. In general, the fluid outlet is in the vessel base under the filter plate to capture the liquid phase of the slurry. In some aspects, when the vessel base is releasably sealed to the vessel wall, the dried solid can be harvested from the R-FWD by releasing the base to access the solid. Alternatively, the R-FWD can further comprise a solids discharge port in the vessel operable to remove the solid fraction of the slurry retained by the filter plate. The solids discharge port can be in the vessel wall at a location adjacent to the filter plate, in the vessel base, or both.

The size and shape of the vessel and the process chamber can and will vary based on the intended use of the R-FWD apparatus and equipment with which the reactor is used. For instance, the size and shape can be designed to accommodate an optimal residence time and reaction conditions (heat and mass transfer) to optimize a reaction process, or to accommodate space restrictions in applications such as standalone chemical and pharmaceutical production systems. Similarly, the size and shape of the process chamber can and will vary considerably to accommodate a desired volume of reaction media in the process chamber. For instance, when the R-FWD is operated as part of a batch system, the vessel’s volume is designed to accept an entire charge of slurry from upstream equipment to keep the idle time of the filter to a minimum, sufficient holding volume is required for fast charging and emptying of the vessel.

As reactors can have uses in diverse fields such as within the food, chemical, and pharmaceutical industries, the size of a reactor vessel and process chamber can and will vary considerably. Reaction volumes of tens of thousands of liters are common. In some aspects, the instant R-FWD can provide a process chamber that can accommodate a volume of reaction media ranging from less than about 1 mL to about 4 Ls or more. In some aspects, the instant reactor can provide a volume ranging from less than about 1 mL to about 3 L, from about 1 L to about 3 Ls, from about 1 mL to about 3 Ls, from about 1 mL to about 20 mL, from about 10 mL to about 400 mL, from about 50 mL to about 400 mL, from about 100 mL to about 500 mL, from about 200 mL to about 500 mL, from about 300 mL to about 500 mL, from about 100 mL to about 400 mL, from about 100 mL to about 300 mL, or from about 150 mL to about 250 mL.

The vessel walls, vessel top, and the vessel base can be constructed of the same or different materials based on the intended use of the R-FWD apparatus. Such materials are known to individuals of skill in the art. Non-limiting examples of materials can be as described herein above. In some aspects, the vessel walls, vessel top, the vessel base, or any combination thereof, is constructed using thermally conductive material or material that can withstand pressures that may accumulate in the reaction chamber.

The vessel walls, vessel top, and vessel base can be constructed from or can comprise portions made of translucent/transparent material for observation during the reaction process, and/or to allow the user to direct specific electromagnetic energy at a specific wavelength into the reactor portion to participate in the reaction process. An example of electromagnetic energy can be UV light to help catalyze a polymerization reaction. Further, the translucent/transparent material can be measurement regions that can accommodate one or more detectors, or one or more conductive areas having different conductive properties. Non-limiting examples of detectors include a camera, an optical microscope, an electron microscope, a spectrometer, a thermocouple, or combinations thereof.

It will be recognized that the vessel can further comprise additional components or parts known to individuals of skill in the art suitable for the intended function of the reactor. Non-limiting examples of additional components or parts can be as described herein further below in Section I(e).

### (B) Filter Plate

Filter plates generally have, but are not limited to, the following properties: (1) an appropriate porosity (that is, the pores should be of such a size that allows sufficient flow of liquid and in some cases certain particle sizes; (2) chemical resistance to the reactants; (3) sufficient mechanical strength to withstand the pressures and vacuums exerted onto the plates; and (4) thermal resistance at the temperature at which the filtration is carried out. The type of filter plate can be determined based on the characteristics of the slurry, including the particular material in the slurry, the particle size and shape, and the cake porosity, and compressibility, which are all factors that, when taken into account with the filter plate selected, will determine filtration rate.

The filter plate comprises porous material and can withstand the weight of the solids and the pressure that is exerted on the surface of the solids. Additional support for filter plates can be provided by support structures in the vessel base. The filter plate can further comprise a perforated support onto which or into which the filter plate is placed. The filter plate can be welded to the base, the vessel walls, or both. Alternatively, the filter plate can be removably attached to the vessel base, vessel walls, or both.

Non-limiting examples of porous materials may include, but are not limited to: a) filtration fabric also known as “paper” or rolled goods; b) synthetic filtration fabrics often referred to as “non-wovens” such as polypropylene, polyethylene, polystyrene, and related polyolefins; fiberglass; polyamides such as nylon (6 and 6/6), KEVLAR, NOMEX; polyesters such as DACRON; polyacrylates, polymethacylates, polyacryonitrile such as ORLON, polyvinyl chlorides and related materials, such as polyvinylidene chloride; polytetrafluoroethylene (PTFE); polyurethanes; copolymers of the above materials; and combinations thereof; c) natural filtration fabric such as cellulose and other paper-based air filters; wool; cotton; fiber glass, carbon fibers; and combinations thereof; d) metal filtration filters such as woven wire, perforated metal, and single or multilayered sintered metals; (e) woven fabric made from fibers such as cotton, nylon 6, polytetrafluorethylene (PTFE), nylon 6.6, nylon 11, nylon 12, HALAR ethylene chlorotrifluoroethylene (E-CTFE), polyester PBT, Polyester PET, polypropylene, acrylics, polyvinyl-den fluoride (PVDF), polyphosphate sulfide (PPS) and high density polyethylene; and any combination thereof. In some aspects, the filter plate is a sintered C-22 Hastelloy™ filter plate with Inconel™ 625.

The R-FWD can comprise a single filter plate or more than one filter plate, each having different filtration properties. When the R-FWD apparatus comprises more than one filter plate, each filter plate can provide a stage of filtration by a specific particle size and be stacked to provide gradual reduction in filtration. The R-FWD can comprise 1, 2, 3, 4, 5, 6, 7, 8, 9, 10 or more filter plates.

### (C) Agitator Assembly

The R-FWD of the instant disclosure comprises an agitator assembly for agitating the reaction media in the process chamber to ensure that sufficient agitation/stirring of a reaction medium can occur. The motion of a liquid / slurry in a reaction medium is directly affected by the agitator / stirrer being used and the shape of the vessel, both of which can affect flow patterns in the vessel thus influencing the level of radial mixing (sideways) and axial mixing (up and down). Agitators can also be very useful in heat transfer applications when it is important that the fluid closest to the wall moves at high velocities. Suitable agitators are readily known to individuals of skill in the art. Non-limiting examples of suitable agitators include overhead stirrers and magnetic stirrers.

In some aspects, the agitator assembly is an overhead stirrer. An overhead stirrer generally comprises an agitator shaft which extends through a port (mixing port) in the vessel into the reaction compartment and the reaction medium. The agitator shaft comprises an impeller disposed in the process chamber for stirring or agitating the reaction medium. For driving the stirrer, a motor or other driving device may be employed, typically outside the reactor body.

Agitator assemblies and reactor designs that can provide flow patterns in the reaction medium for efficient mixing can and will vary depending on the reactor type and size, the reaction medium characteristics, such as viscosity and volume of the reaction medium, and the agitation mechanism used, and are known to individuals of skill in the art. Flow patterns and efficiency of mixing can affect and thus can be used to affect a chemical synthesis process in a reaction medium. Flow patterns and efficiency of mixing can be used to control the rate of a reaction, physical qualities of a solid product of the reation.

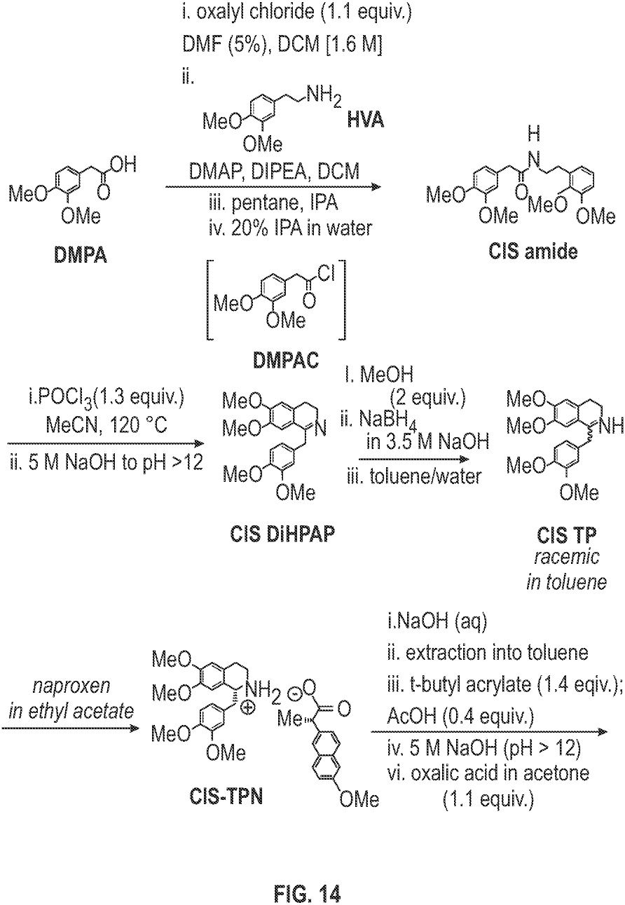

When the agitator is an overhead stirrer, non-limiting examples of configuring agitation components to obtain a desired flow pattern and optimize mixing include impeller configuration, the addition of baffles in the reaction compartment, reactor shape, adjusting the mounting configuration of the stirrer, or any combination thereof. Non-limiting examples of flow patterns that can be generated by some impellers and vessels are shown in FIG. 12.

The shape and design of a vessel of a reactor can also affect flow patterns in the vessel, thereby affecting efficiency of stirring. For instance, in a cylindrical reactor comprising a center-mounted mixer, a very inefficient flow pattern is generated: the tangential velocities from the impeller cause the entire fluid mass to spin. In other words, the entire fluid (and its solids) moves like a merry-go-round. In solid suspension applications, the solid particles will swirl around at the bottom of the tank: no axial (top to bottom) flow is created to lift them up and suspend them in the fluid. Accordingly, agitator assemblies and reactor design of an R-FWD apparatus can further comprise elements, or can be configured to improve efficiency of mixing the reaction medium by the agitator.

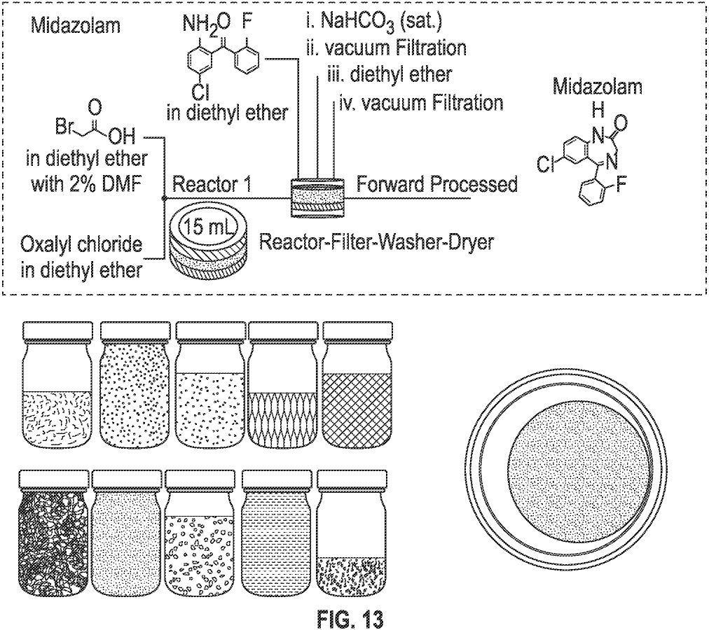

The type and configuration of impeller used will vary from process to process and can be determined experimentally. For instance, in situations involving very viscous fluids where laminar mixing is present, the diameter of the impeller can approach the diameter of the tank. The larger impellers aid in the transport of momentum throughout the tank and ensure that the fluid is moving close to the tank wall. Variations in the configuration of impellers can include variations in the type of impeller such as blade impellers, anchor impellers, and turbine impellers, the number of blades in the impeller, laminar impellers, ribbon impellers, disk style flat blade turbines, curved blade turbines, screw impellers, and the geometry of an impeller, such as the diameter, pitch angle, and width of the blades of the impeller. Non-limiting examples of impeller types and configurations can be as shown in FIG. 11.

The type an geometry of an impeller can be adjusted to control radial mixing (sideways) and axial mixing (up and down). Axial flow impellers cause the tank fluid to flow parallel to the impeller’s axis of rotation, while radial flow impellers cause the tank fluid to flow perpendicular to the impeller’s axis of rotation. Some common but non-limiting geometries for radial flow mixers include disk style flat blade turbines and curved blade turbines, while some common axial flow impellers are the propeller and pitched blade turbine. Axial flow impellers can be further broken down into paddle, turbine, screw-type, helical blade, anchor, gate, propeller to name but a few. Axial flow impellers are very useful in mixing solid-liquid suspensions because they prevent the solid particles from settling at the bottom of the tank. Radial flow impellers can be used in situations where high shear rates are needed, such as in dispersion processes.

In some aspects, an R-FWD apparatus of the instant invention further comprises baffles. As used herein, the term “baffle(s)” refers to structures in the reaction compartment to promote mixing by preventing vortexes from forming during agitation. Baffles can be long “plates” of various shapes, sizes, and configurations in the process chamber that prevent swirling & promote top to bottom fluid movement. They are most commonly used for blending and solid suspensions because these applications often use vertical, cylindrical tanks that tend to create swirling patterns, regardless of the type of impeller being used. Baffle configurations can and will vary depending on the reactor type and size, the reaction medium characteristics, such as viscosity and volume of the reaction medium, and the stirring mechanism used in conjunction with the baffles, and are known to individuals of skill in the art. For instance, the number of baffles, the width of baffles, and the mounting positions of the baffles in the reaction compartment are parameters that can be adjusted to get the best mixing. It is noted that square or rectangular blending tanks are self-baffling and may not need baffles. Baffles can be attached to the interior surface of the reactor vessel, the reactor top, the impeller of the agitator, or any combination thereof. Flow patterns and efficient mixing can also be controlled by adjusting the mounting of the mixer in the process chamber. With axial-flow impellers, an angular off-center position where the impeller is mounted approximately 10-15° from the vertical, can be used. Alternatively, the mixer can be offset while being placed vertically in the tank. The mixer can also be positioned at an angle and offset.

The agitator assembly can also function during washing, drying, and discharging the solids as described herein above. For instance, the agitator assembly can comprise one or more impellers for stirring a reaction medium, keeping the slurry in suspension during filtration, smoothening the filter cake’s surface prior to applying spray wash, resuspending the cake during re-slurring, and agitating the solid and removing cracks in the filter cake during drying, among other functions. The agitator assembly can also be used to facilitate discharge of the filtered solids.

To accomplish these tasks, the agitator assembly can comprise impellers specifically designed for a certain function such as agitating the filter medium, filtering, washing, and drying, or can comprise multifunctional impellers adapted to perform the functions described herein. For instance, the agitator assembly can comprise two arms with slanted blades that rotate in one direction to re-slurry the cake during washing and discharge it at end of cycle. The impellers can smoothen the cake by rotating in one direction and convey the cake for discharge towards the solids discharge port by rotating in the opposite direction. In some aspects, the impeller has no predetermined direction of rotation and is vertically movable to perform the various functions described herein. Examples of types of agitator assemblies that can be used with the present invention include, but are not limited to, helical, anchor, propeller, paddle, and turbine, and can have two, three, four or more blades.

The agitator assembly and/or the rotating impellers of the agitator assembly can be movable along a longitudinal axis extending from the vessel top to the filter plate, and can be raised or lowered to optimally position the impeller in the reactor during a specific function. The agitator assembly and/or the rotating impellers of the agitator assembly can be raised and lowered manually or using mechanical mechanisms such as hydraulic systems and servo motors. Manually raising and lowering the impeller can further comprise securing the impeller at any location along the longitudinal axis in the vessel or at discreet positions using notches and the like. Lowering and raising the impeller can be used to adjust the mixing regime required for a reaction which can be very different from a mixing regime used for a slurry or during redissolution. In an aspect where a reaction generates a slurry or cake, the reactor impeller can initially be raised to a position further from the base plate and can be lowered as the slurry/cake is generated to aid in washing and redissolution of the cake, and further repositioned during a drying step to close cracks and compress the cake to reduce residual moisture level. Further reduction in cake moisture can be obtained by slowly rotating and lowering the paddle arms to scrape and de-lump the cake, and to convey the cake for discharge towards the solids discharge port.

### (D) Ports

In addition to the solids discharge port, the filtrate outlet, and the mixing port (if present) described above, the R-FWD further comprises two or more ports in the body of the reactor in fluid communication with the reaction chamber of the reactor for inserting tubing for material input and output as well as for attaching sensors, probes, filters, connectors, probes, samplers, or other devices. Devices include but are not limited to a filter, a connector, a probe, a sensor, a sampler, and other devices described in Section I(e). The incorporation of various ports into the body of the R-FWD allows for gas flow in and out of the reactor, as well as fluid flow in and out of the reactor. For instance, ports can accommodate headspace gas in, headspace gas out, sparge gas in, reactants and solvents in, catalyst in, culture media in, titrant in, inoculum in, nutrient feeds in, harvest out. It will be understood that the tubing and sensors can be connected to the ports by using any desirable connection technology capable of providing a seal at the port. The ports can be located anywhere in the reactor.

The one or more ports comprise at least one material input port through which reaction material can be introduced to the reaction chamber, and at least one pressure input port for use during drying. The input port can comprise tubing inserted through ports into the reaction medium, or into the headspace of the reactor.

### (E) Other Components

As described above, the R-FWD apparatus of the instant disclosure can further comprise sensors, filters, connectors, probes, samplers, connectors for attaching the reactor to additional devices or systems, or other devices. In some aspects, the reactor comprises connectors for attaching the reactor to a miniature chemical or pharmaceutical manufacturing unit, or a POD unit.

Non-limiting examples of sensors that may be used in conjunction with reactor systems of the instant invention include sensors for fluid flow, temperature, pH, oxygen, pressure, concentration, and sensors that can detect specific compounds in a reaction medium. Fluid flow sensors can sense the rate of reagent or solvent addition which can be adjusted in an adaptive response to real time, or near real time, touchless measurements. Other devices can include pressure relief or other valves such as rupture disks, connectors such as Luer connectors, compression fittings, quick disconnects, aseptic G sterile connectors and other such fitting that would allow for the creation of sterile connections, septums for sampling, filters, bearings such as agitator shaft bearings and bearing assemblies, viewports, and probe ports. Reactors can also comprise devices such as light emitting diodes (LEDs) that direct specific electromagnetic energy at a specific wavelength into the reactor portion to participate in the reaction process. Such devices can direct the energy through portions in the vessel made of translucent/transparent material. Alternatively, electromagnetic energy devices can be embedded into the side walls of the vessel

The reactor can further comprise contact or contactless measuring systems, which may comprise instruments operable to measure, for example, quantity (i.e., volume, weight, etc.), analyte identity and/or concentration, flow rate, temperature, pressure, turbidly, color, reagent use, reagent verification, and product verification (otherwise known as Process Analytical Technology (PAT). The measurement of the reactants or reaction in the reactor may be performed using spectroscopic analysis, ultrasonic detection, or optical detection. Reagent verification, product verification, analyte identity and concentration analysis within the reactor may be performed using a range of analytical instruments, such as liquid chromatography (LC), MS high performance liquid chromatography (HPLC) with or without UV-VIS, UV-VIS-DAD and/or mass spectrometry detectors, electromagnetic radiation spectroscopy, such as UV/Vis NIRF, FTIR, and RAMAN, and combinations thereof.

In some aspects, the reactor system comprises contactless measurement systems for the reactants, or reaction in the reactor may be performed using spectroscopic analysis, ultrasonic detection, or optical detection. In some aspects, reagent verification, product verification, analyte identity, and concentration analysis within the reactor used in the contactless measuring systems may be performed using liquid chromatography (LC), MS high performance liquid chromatography (HPLC) with or without UV-VIS, UV-VIS-DAD and/or mass spectrometry detectors, electromagnetic radiation spectroscopy, such as UV/Vis NIRF, FTIR, and RAMAN, and combinations thereof.

The reactor system can further comprise measuring devices for tracking fluid volume and/or flow rate within the reactor system using ultrasound or camera and machine vision. Ultrasonic fluid level measurement may be performed, for example, using GL Sciences Liquid Level Sensor Reservoir Accessories. Non-limiting examples of suitable ultrasonic flow rate sensors include SonoFlow® CO.55 | Ultrasonic Clamp-On. Liquid volume and flow rate tracking may also be monitored using computer vision and pre-trained instance segmentation computer neural network (CNN). Using this method, the current volume in a transparent reactor using a contactless measurement system may be monitored by computer vision based on the pixel area of liquid to vessel. Computer vision may be used to track the fill line of the liquid contents of a transparent or translucent reactor.

In some aspects, the temperature in the reactor system may be monitored using a touchless temperature sensor. Non-limiting examples of suitable touchless temperature sensors include infrared temperature sensors. Non-limiting examples of commercially available temperature sensors include Melexis Technologies NV part number MLX90614KSF-ACC-000-TU-ND.

In some aspects, washing efficiency may be further improved if air or gas are not allowed to enter the cake in a multi-washing system. This can be achieved using a liquid/moisture level detector that monitors the surface of the cake for moisture. Further, moisture sensors can be used to determine the moisture content of the solids.

A reactor can also comprise a temperature control device operable to control the temperature of the reaction medium. The temperature control device can control temperature by conductive, thermoelectric, resistance heating, impedance, temperature modulation using induction, microwave dielectric heating and any combination thereof. Non-limiting examples of a temperature control device include heat exchanger plates or other heating elements on the exterior of the reactor body, heating elements in the reaction space, and jackets surrounding the reactor body and/or vessel adapted to regulate the temperature of the reaction medium, by providing sources of heating and cooling. In some aspects, the temperature control device is an induction coil, an induction coil support in the vessel base, and a thermistor in the vessel base. In some aspects, the temperature control device is a copper induction coil, an induction coil support in the vessel base, and a Hastelloy™ C276 thermistor in the vessel base.

In some aspects, the agitator comprises controllers for adjusting the speed of agitation to accommodate various reaction conditions and reactor configurations. Non-limiting examples of means for controlling the speed of mixing include adjusting the speed of rotation of an impeller or magnetic stirrer using a variable speed driver. The variable speed driver can be an adjustable frequency AC controller, a DC motor and drive, a steam turbine driver, or a hydraulic variable speed drive unit (“fluid drive”).

The R-FWD apparatus can further comprise a controller in functional communication with components of the apparatus such as the agitator assembly, valves, and sensors, and is operable to provide tight control of the operational sequence of the process on parameters such as temperature and pH. For instance, in some aspects, a controller can perform one or more of the following functions: allow switching on or off components of the system such as a fluid discharge valve, reaction medium inlet valve, agitator assembly, provide controls for system function such as agitator speed, system for raising and lowering of an impeller, and provide monitoring information using data collected by the sensors. The controller can include additional input and output components that permit input by a user (e.g., a touch screen display, a keyboard, a keypad, a mouse, a button, a switch, a microphone, etc.). The controller can also include output components that provide output information (e.g., a display, a speaker, one or more light-emitting diodes (LEDs), etc.).

In addition to the controller, the device can further comprise at least one processor and associated memory adapted to receive the operational and sensor data from the controller. The processor and associated memory can be hard wired to the system or can be networked in a wired or wireless manner. The processor and associated memory can also communicate with a server or other remote computing device in order to execute specific steps. A non-transitory computer readable medium programmed to execute the methods can be loaded on the processor and associated memory or in communication with the system. In some aspects, the processor can be operable to assign one or more event times, wherein each event time indicates the time of a change in the state of a signal received from a component of the system or a sensor. In this aspect, the associated memory can be operable to receive and store the signals and/or outputs of the sensors of the device, and the one or more event times. The storage component may store information and/or software related to the operation and use of the controller. The storage component can include a random-access memory (RAM), a read only memory (ROM), and/or another type of dynamic or static storage device (e.g., a flash memory, a magnetic memory, an optical memory, etc.) that stores information and/or instructions for use by the controller.

In some aspects, it is contemplated that the processor can comprise an alarm system that can be activated in response to one or more inputs from a sensor. In these aspects, it is contemplated that the alarm system can comprise a conventional device for selectively generating optical, thermal, vibrational, and/or audible alarm signals.

In some aspects, when the R-FWD is attached to and used in conjunction with a POD unit operable for production of a pharmaceutical, the controller can be adapted to communicate data with at least one processor and associated memory of the POD unit. For instance, the controller can be operable to communicate a signal to the processor and memory of the POD unit in response to sensor data indicating moisture level in the filter cake. In such instance, the POD unit can switch off the pressure and/or vacuum input in response to a signal received from the treatment system controller, indicating a desired moisture level is reached.

### (F) Aspects of R-FWD

Aspects of an R-FWD apparatus 101 of the instant invention and various elements of the R-FWD apparatus 101 are shown in FIGS. 2-10. The R-FWD apparatus 101 comprises a vessel 110 defining a process chamber 151 that can accommodate the reaction medium (not shown). The vessel 110 comprises vessel walls 120, a vessel top 130 attached to the vessel walls 120 at a first opening 121 of the vessel 110, and a vessel base 140 attached to the vessel walls 120 at a second opening 122 of the vessel 110.

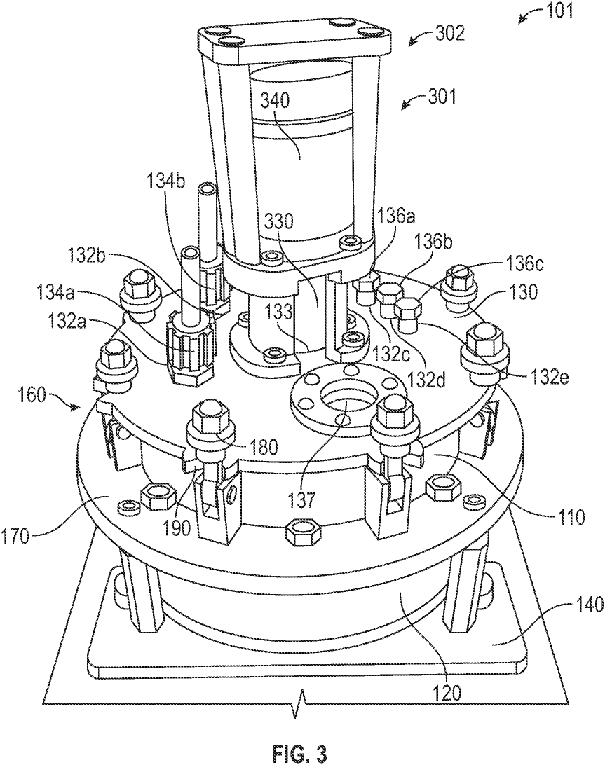

In an aspect shown in FIG. 2, the vessel top 130 and the vessel walls 120 are in one part, and the vessel base 140 is removably sealed to the vessel walls 120. In an aspect shown in FIGS. 3-6, the vessel top 130 and the vessel base140 are removably sealed to the vessel walls 120. As shown in FIGS. 3, 4, and 5, the vessel top 130 is sealed to the vessel walls 120 by a mechanical closure 160 operable to releasably seal the vessel top 130 to the vessel 110. The mechanical closure 160 comprises a bolting ring 170 attached to the vessel walls 120 and fastening notches 190 on the vessel top 130. The bolting ring 170 comprises nut and bolt fasteners 180 operable to engage fastening notches 190 in the vessel top 130 to thereby releasably seal the vessel top 130 to the vessel 110. In this aspect, the R-FWD apparatus 101 comprises ports 132 a-e for material input and output in the vessel top 130 (FIGS. 3 and 4). Ports 132a and port 132b comprise compression fitting 134a and compression fitting 134b attached thereon, respectively, and ports 132 c-e comprise luer fittings 136 a-c attached thereon (not attached to ports 132c-e in FIG. 4). Vessel top 130 further comprises a viewing window 137 Shown in FIGS. 3 and 4) and a burst disk 138 (shown in FIG. 4).

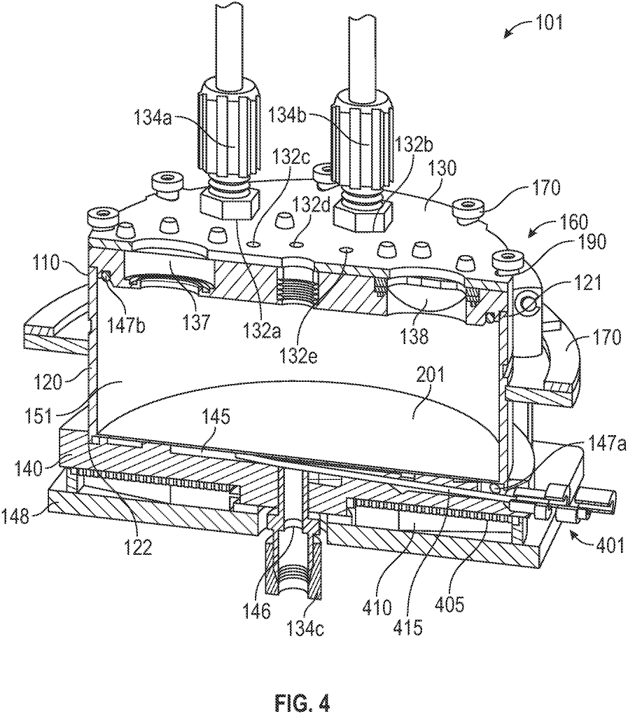

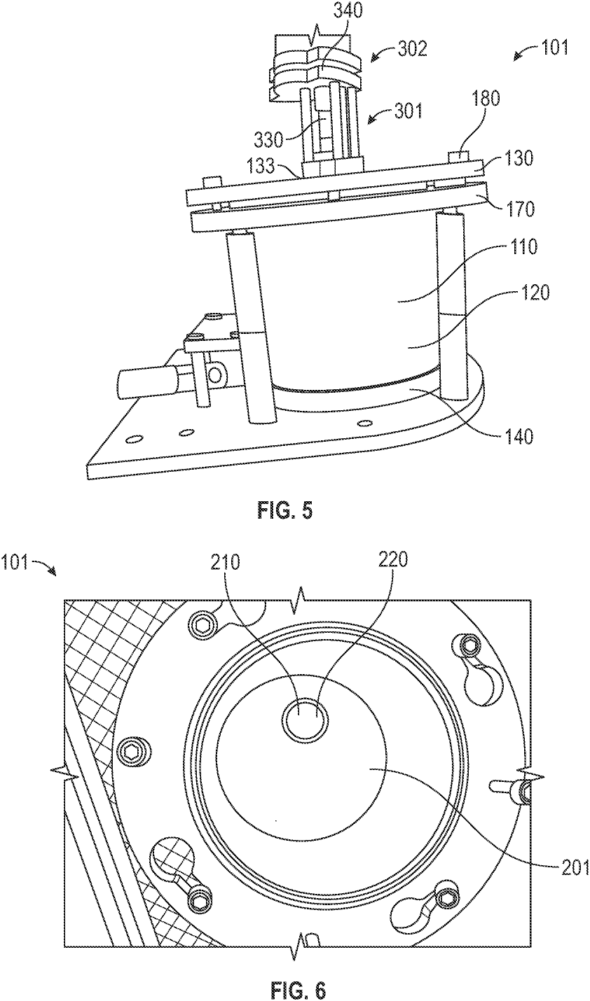

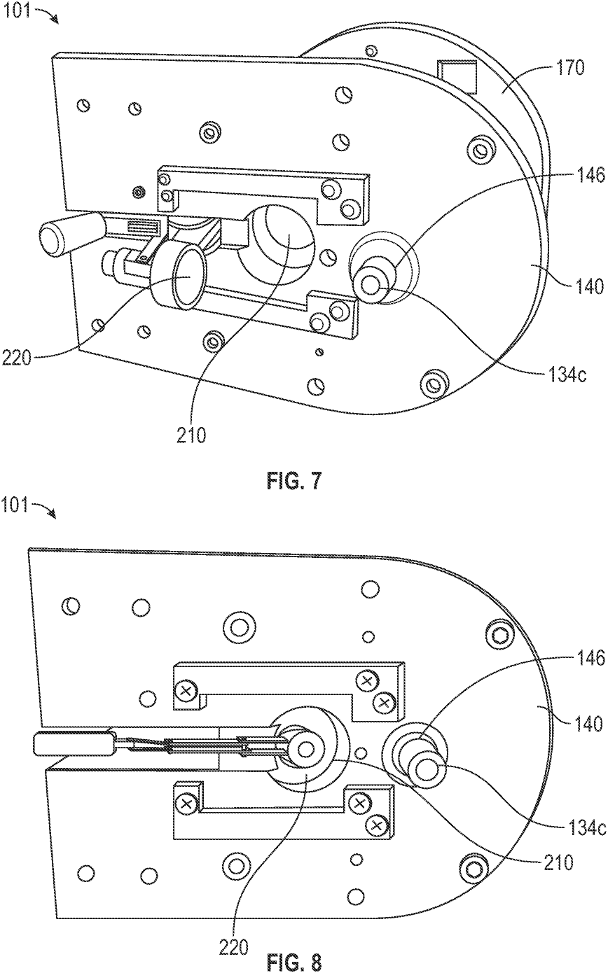

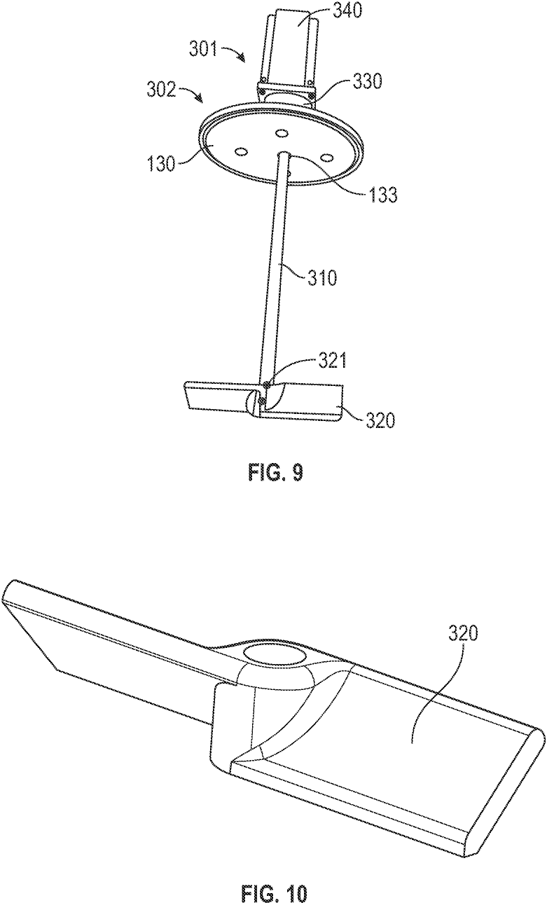

The R-FWD apparatus 101 also comprises a filter plate 201 (FIGS. 2, 4, and 6) laterally disposed on the vessel base 140, a solids discharge port 210 (FIGS. 6-8), and a solids discharge port closure 220 (FIGS. 5, 7, and 8). FIG. 7 shows the solids discharge port closure 220 in the open position. FIG. 8 shows the solids discharge port closure 220 in the closed position.The vessel base 140 provides support for the filter plate 201. In the aspect shown in FIGS. 6-8, the solids discharge port 210 is shown extending through the filter plate 201 and vessel base 140.

The vessel base 140 comprises spaces 145 to guide the filtrate to a fluid outlet 146 (FIG. 4). In this aspect, a compression fitting 134c such as a PFA compression fitting, is inserted or attached to the fluid outlet 146. In FIG. 4, the vessel base 140 is shown attached to the vessel walls 120 with a gasket 147a interposed between the vessel walls 120 and the vessel base 140, and the vessel top 130 is shown attached to the vessel walls 120 with a gasket 147b interposed between the vessel walls 120 and the vessel top 130. In the aspect shown in FIG. 4, the R-FWD apparatus 101 is heated using an induction assembly 401 comprising an induction coil 405, an induction coil support 410, and a thermistor 415 in the vessel base 140. The vessel base 140 is attached to a base plate 148 that can be used to support the R-FWD apparatus 101, or attach the R-FWD apparatus 101 to a miniature chemical or pharmaceutical manufacturing unit, a POD unit, or components thereof.

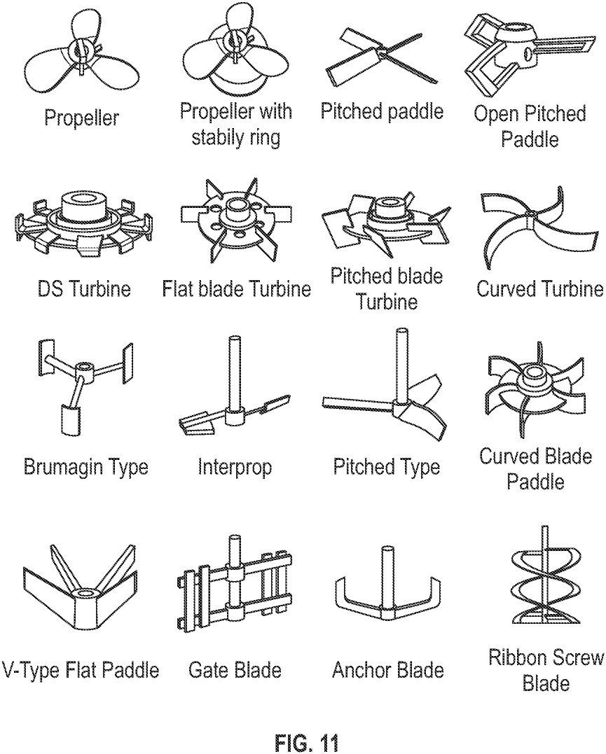

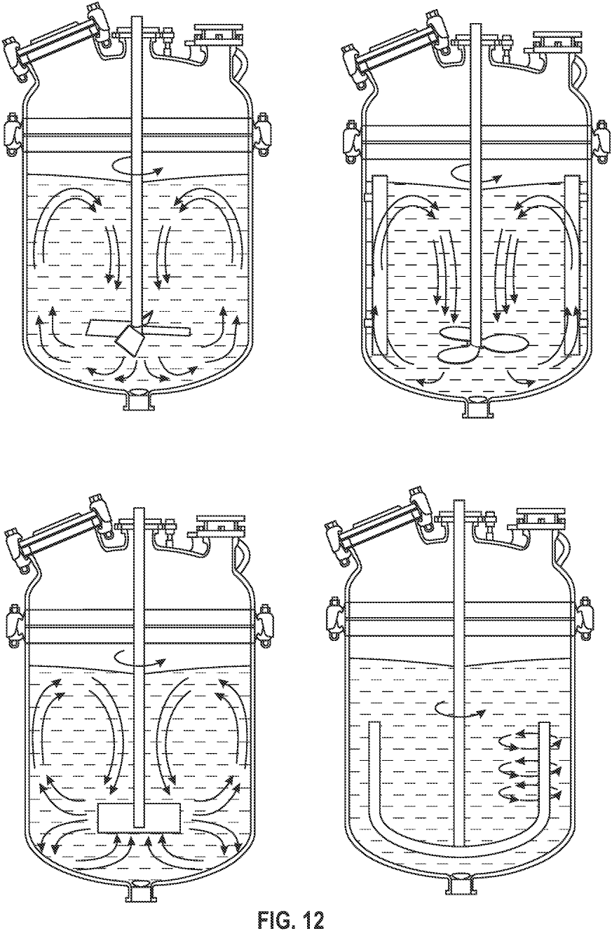

FIGS. 2, 3 and 5 show an aspect of the R-FWD apparatus 101 further comprising an agitator assembly 301. In the aspects shown in FIGS. 2, 3, and 5, the agitator assembly 301 is an overhead stirrer 302. The overhead stirrer 302 generally comprises an agitator shaft 310 which extends through attachment port 133 in the vessel top 130 into the process chamber 151. The agitator shaft 310 comprises an impeller 320 attached at the distal end 321 of the agitator shaft 310. The impeller 320 is disposed in the process chamber 151 of the vessel 110. In FIG. 2, the impeller is shown in contact with a filter cake 345 on the filter plate 201 smoothening the filter cake’s surface 350. A motor 340 is shown attached to the agitator shaft 310 through a flexible coupling 330. FIG. 9 shows the agitator shaft 310 extending through the vessel top. One aspect of an impeller configuration is shown in FIGS. 9 and 10.

### II. Methods

Another aspect of the present disclosure encompasses a method of manufacturing a solid dry compound using a R-FWD to perform a chemical reaction within the reactor, followed by filtering, washing, and drying the compound in an operational sequence of a process for manufacturing a compound. The R-FWD can be as described in Section I herein above. The chemical reaction can be a reaction for producing a chemical compound, a biological compound, an active pharmaceutical compound (API), and a formulated drug product. In some aspects, the chemical reactant is an API. In some aspects, the chemical reactant can be a precursor of an active pharmaceutical ingredient.

In some aspects, a method of synthesizing a chemical compound comprises providing or having provided one or more input materials; introducing the one or more input materials into the process chamber of the R-FWD in a reactor input stream; and subjecting the one or more input materials in the reactor to conditions to cause a chemical reaction between the input materials. In some aspects, the chemical reaction comprises a solid compound. Reaction media comprising the resulting chemical compound is harvested from the reactor by filtering, washing, and drying the solid chemical compound.

The chemical compound can be an active pharmaceutical compound (API) or a precursor of an API. The one or more of the input materials can be a product of a chemical reaction conducted in a second reactor fluidically connected with the reactor. Further, the reactor can be fluidically connected with other modules fluidically connected with the reactor, wherein the modules perform the same or different chemical processes to produce chemical products. Some aspects comprise transporting a fluid (e.g., a chemical reagent, a solvent, or combinations thereof) through the one or more modules fluidically connected in series or in parallel, or combinations thereof. Some aspects comprise transporting a first fluid (e.g., a chemical reagent, a solvent, or combinations thereof) through a first module and a second module fluidically connected to the first module to form a first chemical product (which is output from the second module).

Chemical reagents, solvents, and other variables necessary for synthesizing a compound can and will vary depending on the compound and the method of synthesis used to synthesize the compound. Any suitable chemical reagent can be used in the systems and methods described herein. Generally, the type of reagent that is employed in the system will depend on the chemical product of interest.

Chemical reactants and/or chemical products can be transported into and/or out of the reactor(s) in any suitable form. In certain aspects, one or more of the chemical reactants and/or chemical products transported through the reactors is in the form of one or more solutes. In certain aspects, the solute (e.g., the chemical reactant and/or the chemical solvent) may be present at a relatively high concentration. For example, in some aspects, a chemical reactant and/or a chemical product may be present at a concentration of greater than or equal to about 1 M. In certain aspects, a chemical reactant and/or a chemical product may be present in an amount close to the saturation limit (e.g., within 90%, within 95%, or within 99% of the saturation limit) of the chemical reactant and/or of the chemical product. As will be understood by those skilled in the art, the saturation limit generally refers to the concentration of a solute before the solute begins to precipitate from solution (i.e., form a solid phase of the solute). Several advantages of using fluids comprising a high concentration of solutes include increasing productivity and/or processed materials rates and reducing waste and formation of byproducts.

When the R-FWD is operated as part of a batch system, the vessel’s volume is designed to accept an entire charge of slurry from upstream equipment to keep the idle time of the filter to a minimum, sufficient holding volume is required for fast charging and emptying of the vessel. In certain aspects, any of the methods for the production of a chemical product (e.g., an ingestible pharmaceutical composition) described herein can be continuous processes using the reactor as one module in a complete system. In some aspects, the method for the continuous production of the chemical product (e.g., the ingestible pharmaceutical composition) comprises transporting an input fluid comprising a chemical reactant through one or more reactors. In certain aspects, a chemical reactant is reacted, within the reactor, to produce the solid chemical product (e.g., an API) for filtering, washing, and drying.

Continuous processes generally refer to systems in which precursor enters the system, product exits the system, and the transformation the system is designed to achieve, all occur during at least a portion of the time during which the transformation occurs. As one example, a solid reaction product is harvested, and the liquid fraction of the slurry exits the reactor during at least a portion of the time that the chemical reaction within the reactor is taking place.

Continuous systems that include two or more modules or kits (e.g., reactors, separators, and the like) can be arranged such that transport between the modules within the continuous system occurs during at least a portion of the time during which the modules are performing their intended function (e.g., reaction for a reactor, filtering for an R-FWD, etc.).

In some aspects, a chemical product is produced continuously from one or more precursors of the chemical product when precursors of the chemical product are being transported into the continuous system and chemical product is being transported out of the continuous system during at least portions of the times the components of the continuous system are being operated to produce the finished chemical product. In a process comprising use of an R-FWD, the solid chemical product is produced and continuously filtered.

The conditions prevailing within the internal reactor can be judiciously selected, controlled, and/or maintained, suitably by controlling one or more reaction parameters (e.g. temperature, pressure, residence time, mixing). The R-FWD may be operated to induce, adjust, and/or maintain one or more reaction parameters within the internal reactor. For instance, where the reactor comprises or is associated with a heating or cooling device, the temperature within the internal reactor (and therefore of the reaction mixture) may be selected, maintained, or adjusted—it may be particularly important to apply cooling or otherwise allow heat-exchange to remove heat generated during a reaction by exotherms. Where the reactor comprises or is associated with a pressure adjusting device (e.g. a vacuum pump or autoclave), the pressure (or lack thereof) within the internal reactor (and therefore of the reaction mixture) may be selected, maintained, or adjusted. Where the reactor comprises an agitation element (e.g. for mixing), mixing of the reaction mixture may be facilitated. Where the reactor is configured to receive input from one or more further input flow lines, prevailing reaction conditions (e.g. pH) within the internal reactor (and therefore of the reaction mixture) may be selected, maintained, or adjusted. Alternatively, where the reactor comprises a gas outlet or gas output flow line (as distinct from a reaction mixture output flow line), optionally connected to a scrubber (e.g. soda lime scrubber for scrubbing excess), gaseous input materials and/or gaseous output materials (produced following the chemical reaction) may be conveniently diverted so that an output load carrying output material(s) exiting the reactor comprises a reduced concentration of said gaseous materials relative to the concentration of said gaseous materials in the reaction mixture (i.e., within the reactor). Alternatively, however, such separation of gases (and optional scrubbing) may occur downstream from the reactor, suitably at a collector point (where the output load is collected). Such induction, adjustment, and/or maintenance of one or more reaction parameters within the internal reactor may suitably further facilitate a chemical reaction within the internal reactor.

In some aspects, the reactor of the present invention is used in connection with chemical or pharmaceutical manufacturing machines or units, known as POD units. POD units are comprised of a number of individual production modules that interact with one another in order to perform one or more steps in a chemical production process. In some aspects, the POD units are sufficiently small such that they are suitable for manufacturing pharmaceuticals and finished drug products which are to be directly distributed and/or deployed to pharmacies, hospitals and to patients, rather than depend on pharmaceuticals from a large manufacturing plant.

According to certain aspects, certain of the systems and methods described herein can be used to produce an ingestible pharmaceutical composition. A method for the production of an ingestible pharmaceutical composition may comprise, in some aspects, transporting an input fluid comprising a chemical reactant through a reactor module via a conduit such that the chemical reactant is reacted, within the reactor, to produce an active pharmaceutical ingredient within a reactor output stream.

In some aspects, the fluid transported into the reactor of the present invention, as described above, comprises a solvent. Solvents can be aprotic solvents, protic solvents, organic solvents, and any combination thereof. Non-limiting examples of suitable aprotic solvents include acetone, acetonitrile, diethoxymethane, N,N-dimethylformamide (DMF), dimethyl sulfoxide (DMSO), N,N-dimethylpropionamide, 1,3-dimethyl-3,4,5,6-tetrahydro-2(1 H)-pyrimidinone (DMPU), 1,3-dimethyl-2-imidazolidinone (DMI), 1,2-dimethoxyethane (DME), dimethoxymethane, bis(2-methoxyethyl)ether, N,N-dimethylacetamide (DMAC), 1,4-dioxane, N-methyl-2-pyrrolidinone (NMP), ethyl acetate, ethyl formate, ethyl methyl ketone, formamide, hexachloroacetone, hexamethylphosphoramide, methyl acetate, N-methylacetamide, N-methylformamide, methylene chloride, nitrobenzene, nitromethane, propionitrile, sulfolane, tetramethylurea, tetrahydrofuran (THF), 2-methyl tetrahydrofuran, trichloromethane, and combinations thereof. Suitable examples of protic solvents include, but are not limited to, methanol, ethanol, isopropanol, n-propanol, isobutanol, n-butanol, s-butanol, t-butanol, formic acid, acetic acid, water, and combinations thereof. Suitable organic solvents include, but are not limited to, alkane and substituted alkane solvents (including cycloalkanes), aromatic hydrocarbons, esters, ethers, ketones, combinations thereof, and the like and any combination thereof. Organic solvents that may be employed include, for example, acetonitrile, benzene, butyl acetate, t-butyl methylether, t-butyl methylketone, chlorobenzene, chloroform, chloromethane, cyclohexane, dichloromethane, dichloroethane, diethyl ether, ethyl acetate, diethylene glycol, fluorobenzene, heptane, hexane, isobutylmethylketone, isopropyl acetate, methylethylketone, methyltetrahydrofuran, pentyl acetate, n-propyl acetate, tetrahydrofuran, toluene, and any combination thereof.

It will be understood by those of ordinary skill in the art that the reactors of the present invention can be used to synthesize an active pharmaceutical ingredient (“API”). As used herein, the term “active pharmaceutical ingredient” (also referred to as a “drug”) refers to an agent that is administered to a subject to treat a disease, disorder, or other clinically recognized condition, or for prophylactic purposes, and has a clinically significant effect on the body of the subject to treat and/or prevent the disease, disorder, or condition. Active pharmaceutical ingredients include, for example, without limitation, agents listed in the United States Pharmacopeia (USP). In some aspects, the active pharmaceutical ingredient is one that has already been deemed safe and effective for use in humans or animals by the appropriate governmental agency or regulatory body. For example, drugs approved for human use are listed by the FDA under 21 C.F.R. §§ 330.5, 331 through 361, and 440 through 460, incorporated herein by reference; drugs for veterinary use are listed by the FDA under 21 C.F.R. §§ 500 through 589, incorporated herein by reference. All listed drugs are considered acceptable for use in accordance with the present invention.

In certain aspects, the active pharmaceutical ingredient is a small molecule. Non-limiting examples of active pharmaceutical ingredients include, but are not limited to, adrenergic blocking agents, anabolic agents, androgenic steroids, antacids, anti-asthmatic agents, anti-allergenic materials, anti-cholesterolemic and anti-lipid agents, anti-cholinergics and sympathomimetics, anti-coagulants, anti-convulsants, anti-diarrheal, anti-emetics, anti-hypertensive agents, anti-infective agents, anti-inflammatory agents such as steroids, non-steroidal anti-inflammatory agents, antimalarials, anti-manic agents, anti-nauseants, anti-neoplastic agents, anti-obesity agents, anti-parkinsonian agents, anti-pyretic and analgesic agents, anti-spasmodic agents, anti-thrombotic agents, anti-uricemic agents, anti-anginal agents, antihistamines, anti-tussives, appetite suppressants, benzophenanthridine alkaloids, biologicals, cardioactive agents, cerebral dilators, coronary dilators, decongestants, diuretics, diagnostic agents, erythropoietic agents, estrogens, expectorants, gastrointestinal sedatives, agents, hyperglycemic agents, hypnotics, hypoglycemic agents, ion exchange resins, laxatives, mineral supplements, mitotics, mucolytic agents, growth factors, neuromuscular drugs, nutritional substances, peripheral vasodilators, progestational agents, prostaglandins, psychic energizers, psychotropics, sedatives, stimulants, thyroid and anti-thyroid agents, tranquilizers, uterine relaxants, vitamins, antigenic materials, and prodrugs, etc. Non-limiting examples of APIs include propofol, midazolam, cisatracurium, ciprofloaxin, and others.

As used herein, the term “small molecule” refers to molecules, whether naturally occurring or artificially created (e.g., via chemical synthesis) that have a relatively low molecular weight. Typically, a small molecule is an organic compound (i.e., it contains carbon). The small molecule may contain multiple carbon-carbon bonds, stereocenters, and other functional groups (e.g., amines, hydroxyl, carbonyls, and heterocyclic rings, etc.). In certain aspects, the molecular weight of a small molecule is at most about 1,000 g/mol, at most about 900 g/mol, at most about 800 g/mol, at most about 700 g/mol, at most about 600 g/mol, at most about 500 g/mol, at most about 400 g/mol, at most about 300 g/mol, at most about 200 g/mol, or at most about 100 g/mol. In certain aspects, the molecular weight of a small molecule is at least about 100 g/mol, at least about 200 g/mol, at least about 300 g/mol, at least about 400 g/mol, at least about 500 g/mol, at least about 600 g/mol, at least about 700 g/mol, at least about 800 g/mol, or at least about 900 g/mol, or at least about 1,000 g/mol. Combinations of the above ranges (e.g., at least about 200 g/mol and at most about 500 g/mol) are also possible.

Also as noted above, the reactor can be used with modular systems and the methods described herein can be used to produce ingestible pharmaceutical compositions. Generally, ingestible pharmaceutical compositions refer to those compositions including an active pharmaceutical ingredient and a pharmaceutically acceptable excipient. As used herein, the term “pharmaceutically acceptable excipient” means a non-toxic, inert solid, semi-solid or liquid filler, diluent, encapsulating material or formulation auxiliary of any type. Some non-limiting examples of materials which can serve as pharmaceutically acceptable excipients are sugars such as lactose, glucose, and sucrose; starches such as corn starch and potato starch; cellulose and its derivatives such as sodium carboxymethyl cellulose, methylcellulose, hydroxypropylmethylcellulose, ethyl cellulose, and cellulose acetate; powdered tragacanth; malt; gelatin; talc; excipients such as cocoa butter and suppository waxes; oils such as peanut oil, cottonseed oil; safflower oil; sesame oil; olive oil; corn oil and soybean oil; glycols such as propylene glycol; esters such as ethyl oleate and ethyl laurate; agar; detergents such as Tween 80; buffering agents such as magnesium hydroxide and aluminum hydroxide; alginic acid; water (e.g., pyrogen free water); isotonic saline; citric acid, acetate salts, Ringer’s solution; ethyl alcohol; and phosphate buffer solutions, as well as other non-toxic compatible lubricants such as sodium lauryl sulfate and magnesium stearate, as well as coloring agents, releasing agents, coating agents, sweetening, flavoring and perfuming agents, preservatives and antioxidants can also be present in the composition, according to the judgment of the formulator.

The reactor can also be used with modular systems and the methods described herein to produce pharmaceutical compositions for parenteral administration (including subcutaneous, intradermal, intravenous, intramuscular, and intraperitoneal). Formulations for parenteral administration can be an aqueous or an oil-based solution. Aqueous solutions may include a sterile diluent such as water, saline solution, a pharmaceutically acceptable polyol such as glycerol, propylene glycol, or other synthetic solvents; an antibacterial and/or antifungal agent such as benzyl alcohol, methyl paraben, chlorobutanol, phenol, thimerosal, and the like; an antioxidant such as ascorbic acid or sodium bisulfite; a chelating agent such as etheylenediaminetetraacetic acid; a buffer such as acetate, citrate, or phosphate; and/or an agent for the adjustment of tonicity such as sodium chloride, dextrose, or a polyalcohol such as mannitol or sorbitol. The pH of the aqueous solution may be adjusted with acids or bases such as hydrochloric acid or sodium hydroxide. Oil-based solutions or suspensions may further comprise sesame, peanut, olive oil, or mineral oil.

For topical (e.g., transdermal or transmucosal) administration, penetrants appropriate to the barrier to be permeated are generally included in the preparation. Transmucosal administration may be accomplished through the use of nasal sprays, aerosol sprays, tablets, or suppositories, and transdermal administration may be via ointments, salves, gels, patches, or creams as generally known in the art.

Typical applications: Hydrogenation reactor, Polymerization reactor, Synthesis reactor, Catalyst testing / evaluation, Catalytic reactor, Corrosion measurement, Crystallization, Chemical research, Petrochemical research, Biopolymer Research, Nanoparticle synthesis, Corrosion testing autoclave.

In some aspects, a method of the instant invention comprises using the R-FWD apparatus to synthesize midazolam. In some aspects, a method of the instant invention comprises using the R-FWD apparatus to synthesize midazolam as described in Example 1.

In some aspects, a method of the instant invention comprises using the R-FWD apparatus to purify R-naproxen from a racemic mixture. In some aspects, a method of the instant invention comprises using the R-FWD apparatus to purify R-naproxen from a racemic mixture as described in Example 2.

In some aspects, a method of the instant invention comprises using the R-FWD apparatus to synthesize morpholine hydrochloride. In some aspects, a method of the instant invention comprises using the R-FWD apparatus to synthesize morpholine hydrochloride as described in Example 3.

### III. Kits

Aspects of the invention further encompass kits of fan assemblies, filtration units and air filters, wherein each kit is custom made for a specific application for producing and collecting a specific chemical or biological compound. The kits can include one or more R-FWD, one or more reactor filtration units, one or more air filters, one or more ducting, and combinations thereof. The one or more R-FWD apparatus can include R-FWDs having different specifications of size and reaction conditions and filter plates of various sizes and capabilities. The kits can be used for reactions that have particularly hazardous gaseous reagents, products, and by-products, e.g., acid chloride generation (HCI), carbon monoxide, diazomethane, etc. Solvents, which are used regularly by scientists across industries, will have daily exposure limits and therefore will require sufficient air filtration, e.g., dichloromethane, 2-methyltetrahydrofuran etc. Guidance on appropriate conditioning and control of hazardous chemical fumes and other material in laboratories include the ACS CCS and the BMBL and NIH as described herein above.

### DEFINITIONS

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant, both in relation to the other endpoint, and independently of the other endpoint.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The terms “cake” and “filter cake” are used interchangeably and refer to the bed of solids (insoluble material) deposited on the filter plate after or during filtration of a slurry.

As various changes could be made in the above-described cells and methods without departing from the scope of the invention, it is intended that all matter contained in the above description and in the examples given below, shall be interpreted as illustrative and not in a limiting sense.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It will be understood by those of skill in the art that the R-FWD of the present invention does not need to operate within a POD unit and can be used in conjunction with any other unit operation module in a synthetic process. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Synthesis of Midazolam in a Pharmaceutical on Demand (POD) Unit

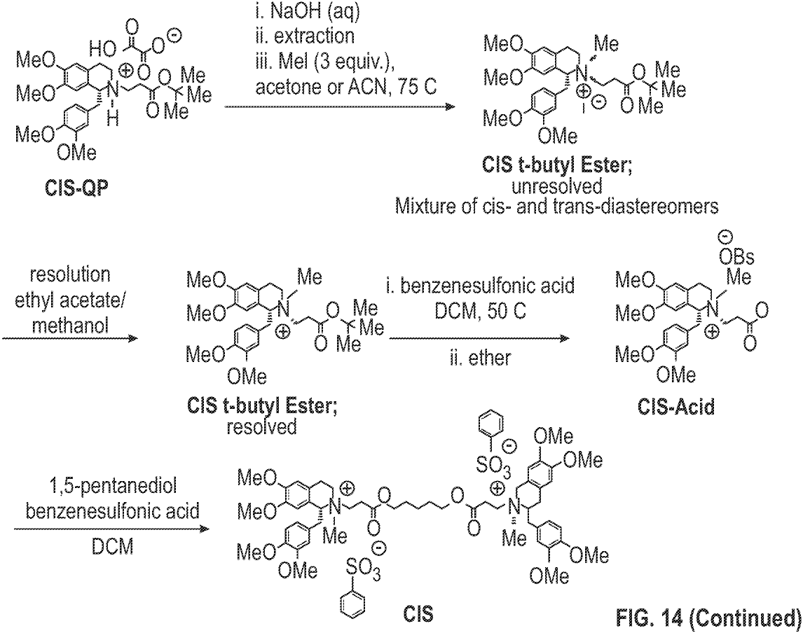

An R-FWD apparatus of the instant invention can be used in a final step in a synthetic process for production of midazoilam. In a POD unit, the production of Midazolam starts with two commercially available starting materials: bromoacetic acid (1) and a benzophenone (2) (FIG. 13). The bromoacetic acetic acid is transformed into the more reactive acid chloride derivative in a first reactor of the POD unit using oxalyl chloride and dimethylformamide (DMF). This material is transferred to an R-FWD where it is reacted with benzophenone (2) in diethyl ether using the reactor function of the R-FWD. Bromoacetyl chloride, benzophenone, a quench are introduced into the R-FWD Upon mixing, instantaneous phase transformation occurs forming a yellowish solid precipitate comprising midazolam. Once the entire charge of material to the vessel is complete, the reaction phase is allowed to continue for an additional time period. Filtration of the mother liquor occurs through the filter plate by applying a vacuum through the filtrate outlet by means of a vacuum pump. In an alternative aspect,this could also be achieved by applying a head-space pressure using inert gas. Once filtered, the cake undergoes a cycle of slurry and displacement washes to remove impurities from the cake. A final drying step is performed yielding an off-white fluffy powder that can be isolated through the trap door and stored or forward processed to the next-part of the equipment train. The remaining solid can be washed, and then dissolved through the addition of water or another adequate solvent. Once fully dissolved the solution can be pushed or drawn through the base-plate to waste or for recycling. This leaves the vessel free and ready for the next reaction cycle.

### Example 2. Purification of R-naproxen From a Racemic Mixture in A Pharmaceutical on Demand (POD) Unit

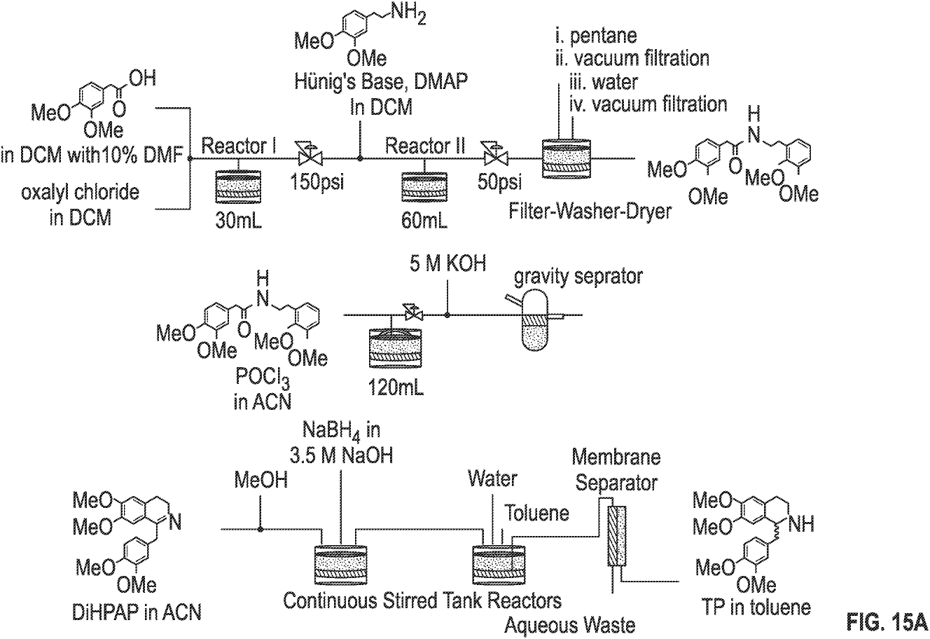

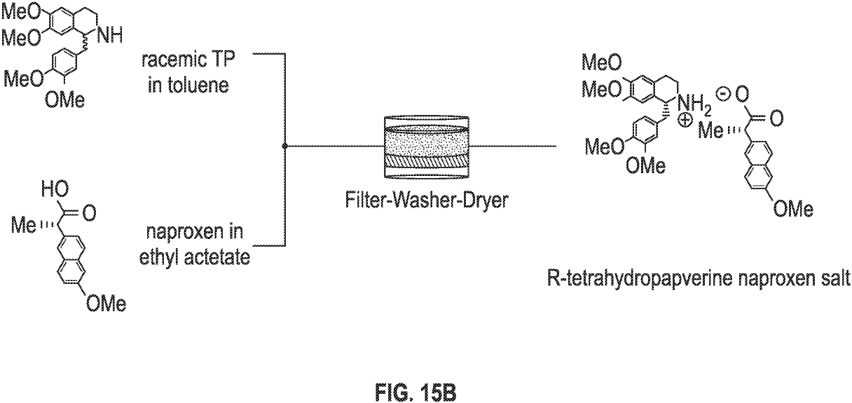

In an aspect, naproxen is made in a continuous process and the chemical process is depicted schematically in FIG. 14. As shown in FIG. 15A, in a first continuous stirred tank reactor (CSTR), dimethoxy phenylacetic acid is reacted with oxalyl chloride in dichloromethane, and then the chlorinated product DMPAC is then reacted in an R-FWD of the present invention with homovanillic acid, and, without the need to transfer the reaction to a dedicated FWD, the resulting slurry is filtered through the filter plate of the R-FWD to create the precursor cis-amide. Cis-amide is combined in POCl₃ with acetonitrile (ACN) in an R-FWD and the effluent is mixed with 5M KOH to neutralize the reaction and, without the need to transfer the reaction to a dedicated FWD, the reaction is then separated in the R-FWD to give dihydroxy papaverine (DIHPAP) in ACN. The resulting DIHPAP is mixed with NaHB₄ and NaOH in an R-FWD to reduce the nitrogen, which is then pumped into a third reactor with water and toluene to give racemic R,S,-tetrahydropapverine (TP). As shown in FIG. 15B racemic R,S,-tetrahydropapaverine (TP) which is then separated with R,S naproxen to separate the R and S stereoisomers and produce the R- tetrahydropapaverine naproxen salt. The remaining reactions are illustrated in FIG. 14 which result in resolved 1R-cis, ‘R-cis-2,2′-(3,11 dioxo-4,10-dioxatridecylene)-bis-(1,2,3,4-tetrahydro-6,7 dimethoxy-2-methoxyl-1-veratrylisoquinolinium) salts.

### Example 3. Production of an Intermediate in the Manufacture of Midazolam in A Pharmaceutical on Demand (POD) Unit

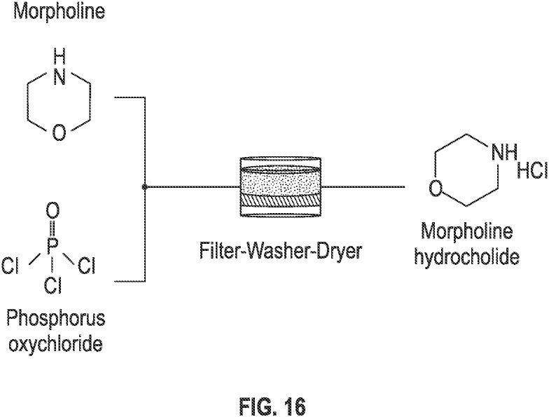

In an aspect, morpholine hydrochloride, an intermediate in the manufacture of Midazolam using an R-FWD of the instant invention is shown in FIG. 16. Morpholine and phosphorus oxychloride in toluene are pumped into a chilled R-FWD. A precipitate (morpholine.HCl) forms instantaneously. Once the reaction is completed, the material is filtered through the base-plate using vacuum or nitrogen head-space pressurization. This material is the reaction product and is forward processed to the next part of the equipment train. The remaining solid can be washed, and then dissolved through the addition of water or another adequate solvent. Once fully dissolved the solution can be pushed drawn through the base-plate to waste or for recycling. This leaves the vessel free ready for the next reaction cycle.

What is claimed is:

1. A reactor filter washer dryer (R-FWD) apparatus comprising:
a. a vessel (110) defining a process chamber (151), the vessel (110) comprising vessel walls (120), a vessel top (130) attached to the vessel walls (120) at a first opening (121) of the vessel (110), and a vessel base attached to the vessel walls (120) at a second opening (122) of the vessel (110);
b. a filter plate (201) laterally disposed on the vessel base (140) wherein the filter plate (201) is operable to retain a solid fraction of a slurry comprising a solid fraction and a liquid fraction;
c. an overhead stirrer (302) comprising:
i. an agitator shaft (310) and an impeller (320) and, wherein the impeller (320) is laterally disposed within the vessel (110) above the filter plate (201), wherein the agitator shaft (310) extends through a mixing port (132b) in the vessel (110) into the process chamber (151), wherein the impeller (320) is attached at a distal end agitator shaft (310), and wherein the overhead stirrer (302) is movable along a longitudinal axis (303) extending from the vessel top (130) to the filter plate (201);
ii. a motor (340) attached to the agitator shaft (310) and operable to rotate the agitator shaft (310) about its longitudinal axis (303);
d. a solids discharge port (132b) (210) in the vessel (110) operable to remove the solid fraction of the slurry retained by the filter plate (201); and
e. an fluid outlet (146) in the vessel (110) for outflowing a liquid phase of the slurry filtered through the filter plate (201).

2. The apparatus of claim 1, wherein the vessel base (140) and vessel top (130) are releasably sealed to the vessel walls (120).

3. The apparatus of claim 1, wherein the vessel (110) further comprises a first gasket (147) interposed between the vessel base (140) and the vessel walls (120), a second gasket (147) interposed between the vessel top (130) and the vessel walls (120).

4. The apparatus of claim 3, wherein the gasket (147) is an EPDM gasket, an FEP-encapsulated silicone gasket, or a Kalrez-encapsulated gasket.

5. The apparatus of claim 1, wherein the impeller (320) has no predetermined direction of rotation and is vertically movable along the longitudinal axis (303) to raise and lower the impeller (320).

6. The apparatus of claim 1, wherein the impeller (320) is operable to stir a reaction medium in the process chamber, keep the slurry in suspension during filtration, smoothen a filter cake’s surface prior to applying spray wash, resuspend the cake during re-slurring, agitate the solids and removing cracks in the filter cake (350) during drying, or any combination thereof.

7. The apparatus of claim 1, wherein the filter plate (201) is a perforated support plate with filter mesh (metallic or non-metallic), wherein the filter plate (201) is welded multi-layer mesh, sintered wire mesh, or any combination thereof.

8. The apparatus of claim 1, wherein the filter plate (201) is a sintered C-22 Hastelloy™ filter plate with Inconel™ 625.

9. The apparatus of claim 1, wherein the solids discharge port (210) is in the vessel base (140).

10. The apparatus of claim 1, wherein the apparatus further comprises a temperature control device operable to control the temperature of a reaction medium in the process chamber.

11. The apparatus of claim 10, wherein the temperature control device is selected from a conduction device, a thermoelectric device, a resistance device, an impedance device, an induction device, a microwave dielectric heating device, and any combination thereof.

12. The apparatus of claim 1, wherein the vessel (110) is made of a Hastelloy™ C-276 6 inch schedule 10 pipe welded to a sintered C-22 Hastelloy™ filter plate (201) with Inconel™ 625.

13. The apparatus of claim 1, wherein the apparatus further comprises a controller in functional communication with valves, sensors, and the overhead stirrer.
